(19) United States
(12) Patent Application Publication
(10) Pub. No.: US 2022/0065382 A1
(43) Pub. Date: Mar. 3, 2022

(54) REFRIGERATOR

(71) Applicant: Toshiba Lifestyle Products & Services Corporation, Kawasaki-shi (JP)

(72) Inventors: Koichi AKIYOSHI, Kasugai-shi (JP); Kengo MATSUNAGA, Nagoya-shi (JP); Hiromichi MOTOI, Owariasahi-shi (JP)

(73) Assignee: Toshiba Lifestyle Products & Services Corporation, Kawasaki-shi (JP)

(21) Appl. No.: 17/420,874

(22) PCT Filed: Jan. 6, 2020
(86) PCT No.: PCT/JP2020/000041

§ 371 Date: Jul. 6, 2021

(30) Foreign Application Priority Data
Jan. 7, 2019 (JP) 2019-000855

(51) Int. Cl. F16L 59/02; F25D 27/00; F25C 1/25; F25D 23/02

(52) U.S. Cl. CPC F16L 59/02; F25D 27/00; F25D 11/02; F25D 23/02; F25C 1/25

(57) ABSTRACT

A refrigerator includes a housing, a door, and an interior member. The housing includes a storage chamber. The door closes the storage chamber to be openable. The interior member is disposed inside the housing. At least part of at least one of the housing, the door, and the interior member is formed of a light-transmitting heat-insulating material containing aerogel, xerogel, or cryogel.

### TECHNICAL FIELD

Embodiments of the present invention relate to a refrigerator. Priority is claimed on Japanese Patent Application No. 2019-000855, filed Jan. 7, 2019, the content of which is incorporated herein by reference.

### BACKGROUND ART

A refrigerator including a housing having a storage chamber, a door closing the storage chamber configure to open, and an interior member disposed inside the housing is known. Such a refrigerator is expected to further improve convenience.

### CITATION LIST

### Patent Literature

[Patent Literature 1]

Japanese Unexamined Patent Application, First Publication No. 2004-340420

### SUMMARY OF INVENTION

### Technical Problem

An object to be solved by the present invention is to provide a refrigerator capable of improving convenience.

### Solution to Problem

A refrigerator of the embodiment includes a housing, a door, and an interior member. The housing includes a storage chamber. The door closes the storage chamber so as to be openable. The interior member is disposed inside the housing. At least part of at least one of the housing, the door, and the interior member is formed of a light-transmitting heat-insulating material containing aerogel, xerogel, or cryogel.

### BRIEF DESCRIPTION OF DRAWINGS

FIG. 1 is a front view showing a refrigerator of a first embodiment.

FIG. 2 is a cross-sectional view taken along a line F2-F2 of FIG. 1.

FIG. 3 is a perspective view showing a schematic configuration of a refrigerator of the first embodiment.

FIG. 4 is a rear view showing a back surface of a door of the first embodiment.

FIG. 5 is a cross-sectional view of a right refrigerating chamber door taken along a line F5-F5 of FIG. 1.

FIG. 6 is a cross-sectional view illustrating a right refrigerating chamber door of a first modified example of the first embodiment.

FIG. 7 is a cross-sectional view illustrating a right refrigerating chamber door of a second modified example of the first embodiment.

FIG. 8 is a cross-section view illustrating a lighting unit of a refrigerator of a second embodiment.

FIG. 9 is a cross-sectional view illustrating a refrigerator of a third embodiment.

FIG. 10 is a bottom view of a first partition wall upper member of a first partition wall of the third embodiment as viewed from below.

FIG. 11 is a cross-sectional view illustrating a refrigerator of a modified example of the third embodiment.

FIG. 12 is a cross-sectional view illustrating a refrigerator of a fourth embodiment.

FIG. 13 is a cross-sectional view illustrating a refrigerator of a modified example of the fourth embodiment.

FIG. 14 is a cross-sectional view illustrating a refrigerator of a fifth embodiment.

FIG. 15 is a cross-sectional view illustrating a refrigerator of a sixth embodiment.

FIG. 16 is a cross-sectional view illustrating a refrigerator of a seventh embodiment.

FIG. 17 is a cross-sectional view illustrating a refrigerator of an eighth embodiment.

FIG. 18 is a cross-sectional view illustrating a refrigerator of a ninth embodiment.

### DESCRIPTION OF EMBODIMENTS

Hereinafter, refrigerators of embodiments will be described with reference to the drawings. In the description below, configurations having the same or similar functions are designated by the same reference numerals. Redundant description of these configurations may be omitted. In the specification, the left and right sides are defined based on a direction in which a user standing in front of the refrigerator sees the refrigerator. In the refrigerator, the side closer to the user standing in front of the refrigerator is defined as the “front side” and the side far from the user is defined as the “rear side”. In the specification, the “width direction” means the left and right direction in the above definition. In the specification, the “depth direction” means the front and rear direction in the above definition. In the specification, “having light transmission” means that one has a property of transmitting at least part of light and may be transparent or translucent.

### First Embodiment

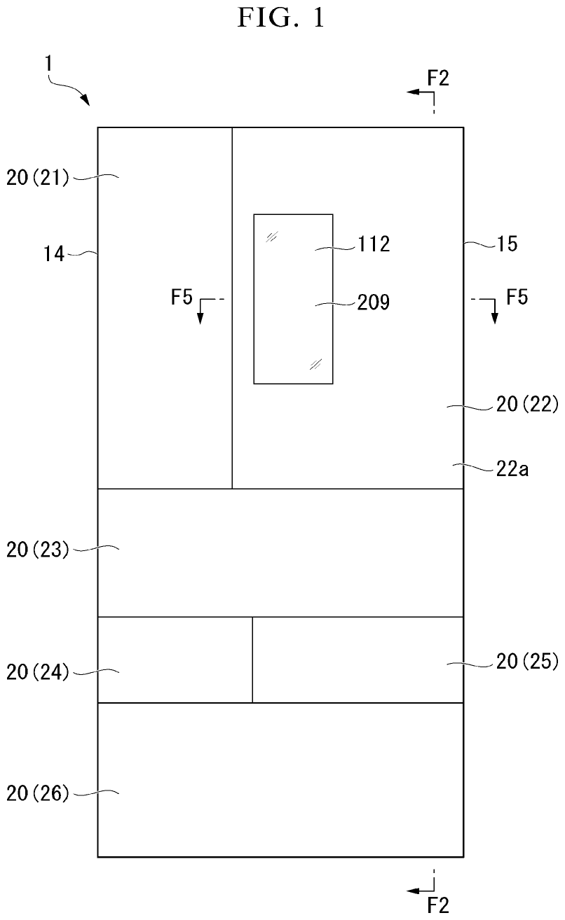

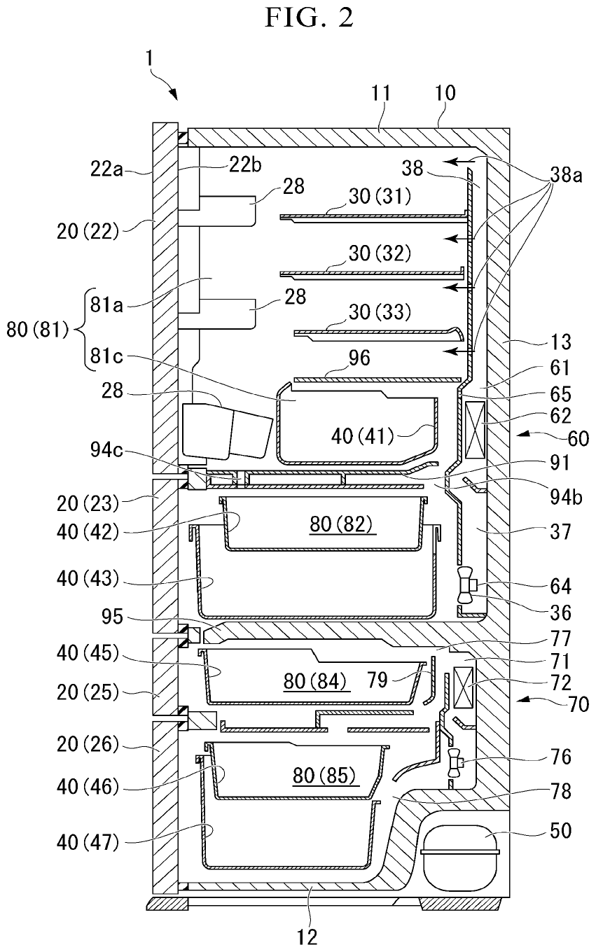

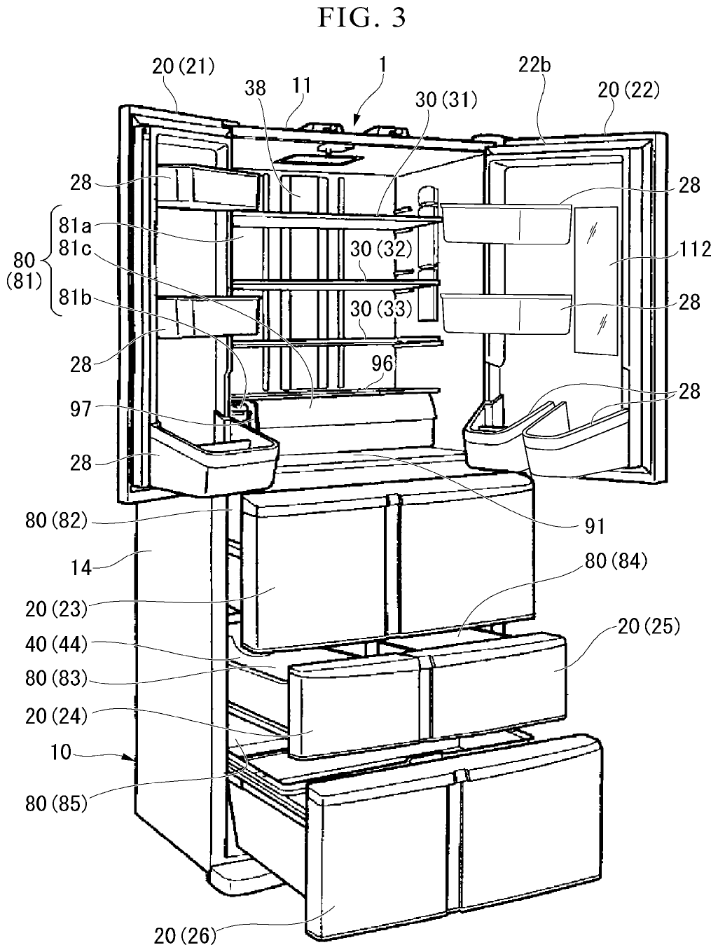

FIG. 1 is a front view illustrating a refrigerator 1 of a first embodiment. FIG. 2 is a cross-sectional view taken along a line F2-F2 of FIG. 1. FIG. 3 is a perspective view illustrating a schematic configuration of the refrigerator 1 of the first embodiment. The refrigerator 1 includes, for example, a housing 10, a plurality of doors 20 (21 to 26), a plurality of shelves 30 (31 to 33), a plurality of containers 40 (41 to 47), a compressor 50, a first cooling mechanism 60, and a second cooling mechanism 70. As will be described later, a right refrigerating chamber door 22 includes a window portion 112 through which the user can visually recognize the inside of a refrigerating chamber 81 from an outside of the refrigerator 1. As will be described later, the window portion 112 includes a specific heat-insulating material 209.

The housing 10 includes, for example, an outer box, an inner box, and a heat-insulating material filled between the outer box and the inner box and has heat-insulating properties. The heat-insulating material is a foamed heat-insulating material such as urethane foam. The housing 10 includes a ceiling wall 11, a bottom wall 12, a rear wall 13, a left wall 14, and a right wall 15.

A plurality of storage chambers 80 are provided inside the housing 10. The plurality of storage chambers 80 include, for example, a refrigerating chamber 81, a vegetable chamber 82, an ice-making chamber 83 (see FIG. 3), a small freezing chamber 84, and a main freezing chamber 85. In the first embodiment, the refrigerating chamber 81 is disposed at the uppermost portion, the vegetable chamber 82 is disposed below the refrigerating chamber 81, the ice-making chamber 83 and the small freezing chamber 84 are disposed below the vegetable chamber 82, and the main freezing chamber 85 is disposed below the ice-making chamber 83 and the small freezing chamber 84. The arrangement of the storage chamber 80 is not limited to the above-described example. As the arrangement of the storage chamber 80, for example, the arrangement of the vegetable chamber 82 and the main freezing chamber 85 may be reversed. In the housing 10, an opening is formed on a front surface side of each storage chamber 80 so that food is allowed to be taken in and out of each storage chamber 80.

The plurality of doors 20 (21 to 26) include a left refrigerating chamber door 21, a right refrigerating chamber door 22, a vegetable chamber door 23, an ice-making chamber door 24, a small freezing chamber door 25, and a main freezing chamber door 26. The left refrigerating chamber door 21 and the right refrigerating chamber door 22 close the refrigerating chamber 81 so as to be openable. The vegetable chamber door 23 closes the vegetable chamber 82 so as to be openable. The ice-making chamber door 24 closes the ice-making chamber 83 so as to be openable. The small freezing chamber door 25 closes the small freezing chamber 84 so as to be openable. The main freezing chamber door 26 closes the main freezing chamber 85 so as to be openable.

The housing 10 includes a first partition wall 91 and a second partition wall 95. The first partition wall 91 is a partition wall which is provided in a substantially horizontal direction. The first partition wall 91 is provided between the refrigerating chamber 81 and the vegetable chamber 82 and partitions the refrigerating chamber 81 from the vegetable chamber 82. The second partition wall 95 is a heat-insulating partition wall which is provided in a substantially horizontal direction. The second partition wall 95 is provided between the vegetable chamber 82 and the ice-making chamber 83 and the small freezing chamber 84 and partitions the vegetable chamber 82 from the ice-making chamber 83 and the small freezing chamber 84.

The first partition wall 91 includes one or more front vents 94c on the front side of the depth direction. The front vent 94c is a through-hole penetrating the first partition wall 91. The refrigerating chamber 81 and the vegetable chamber 82 communicate with each other by the front vent 94c. One or more corners on the inner side of the first partition wall 91 in the depth direction are formed in a notch shape to form a rear vent 94b. The rear vent 94b is a through-hole penetrating the first partition wall 91. The refrigerating chamber 81 and the vegetable chamber 82 communicate with each other by the rear vent 94b. The first partition wall 91 may include at least one of the front vent 94c and the rear vent 94b.

The refrigerating chamber 81 is provided with a normal refrigerating chamber 81a, an ice-making water supply tank chamber 81b, and a chilled chamber 81c. The ice-making water supply tank chamber 81b and the chilled chamber 81c are provided at the lowermost portion inside the refrigerating chamber 81 (the upper portion of the first partition wall 91). The ice-making water supply tank chamber 81b and the chilled chamber 81c are provided below at least part of the normal refrigerating chamber 81a. For example, the ice-making water supply tank chamber 81b is located on the left side and the chilled chamber 81c is located on the right side when viewed from the user.

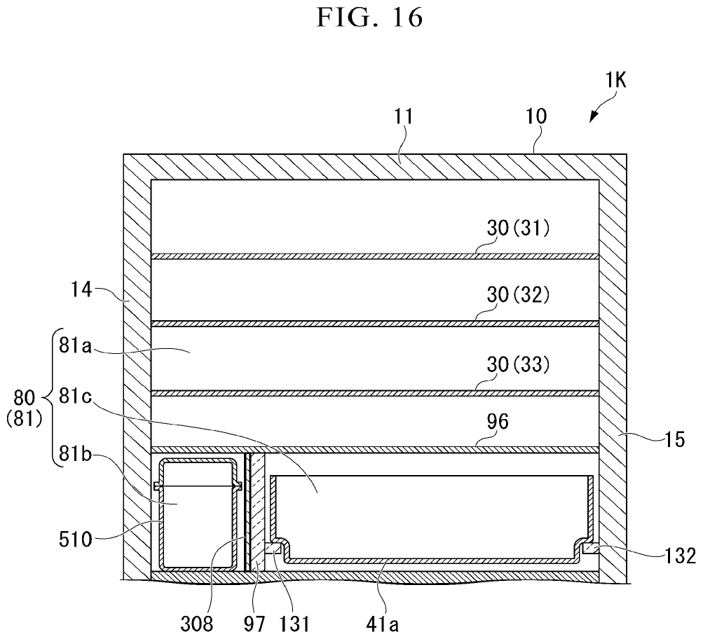

A chilled chamber upper surface partition portion 96 which is provided in a substantially horizontal direction partitions the normal refrigerating chamber 81a and the chilled chamber 81c and partitions the normal refrigerating chamber 81a and the ice-making water supply tank chamber 81b. An ice-making water supply tank chamber partition wall 97 which is provided in a substantially vertical direction (see FIGS. 3 and 16) partitions the ice-making water supply tank chamber 81b and the chilled chamber 81c. The normal refrigerating chamber 81a and the ice-making water supply tank chamber 81b are examples of the “first storage portion”. The chilled chamber 81c is an example of the “second storage portion”. In this embodiment, the chilled chamber upper surface partition portion 96 and the ice-making water supply tank chamber partition wall 97 are shown as an example of the “partition member” that partitions the inside of the refrigerating chamber 81 into the first storage portion and the second storage portion.

Both the refrigerating chamber 81a and the vegetable chamber 82 are kept in a refrigerating temperature zone (for example, 1 to 5° C.). The refrigerating temperature zone (for example, 1 to 5° C.) is, for example, an example of the temperature in the first storage portion. The chilled chamber 81c is kept in a chilled temperature zone (for example, 0 to 1° C.). The chilled temperature zone (for example, 0 to 1° C.) is, for example, an example of the temperature of the second storage portion. That is, the second storage portion (the chilled chamber 81c) is cooled to a temperature zone lower than that of the first storage portion (the refrigerating chamber 81 a and the vegetable chamber 82).

An ice-making water supply tank 510 storing ice-making water is disposed in the ice-making water supply tank chamber 81b. The ice-making water supply tank 510 is disposed on the side of the chilled chamber 81c. A water receiving container (not shown) is installed behind the ice-making water supply tank chamber 81b. A water supply mechanism is provided between the ice-making water supply tank chamber 81b and the water receiving container. The water supply mechanism is a mechanism for supplying water of the ice-making water supply tank 510 (see FIG. 16) of the ice-making water supply tank chamber 81b to the water receiving container. The water supply mechanism pumps water in the ice-making water supply tank 510 by, for example, operating a pump and supplies the pumped water to a water receiving container through a water supply pipe. The water supplied to the water receiving container is supplied to an ice tray of an automatic ice-making device (not shown) in the ice-making chamber 83 through another water supply pipe. The ice-making water supply tank 510 is an example of the “water storage container”.

The plurality of shelves 30 are provided in the refrigerating chamber 81. The plurality of containers 40 include a chilled case 41 which is provided in the chilled chamber 81c of the refrigerating chamber 81, a first vegetable chamber container 42 and a second vegetable chamber container 43 which are provided in the vegetable chamber 82, an ice-making chamber container 44 (see FIG. 3) which is provided in the ice-making chamber 83, a small freezing chamber container 45 which is provided in the small freezing chamber 84, and a first main freezing chamber container 46 and a second main freezing chamber container 47 which are provided in the main freezing chamber 85.

The first cooling mechanism 60 (the cooling mechanism of the refrigerating temperature zone) includes, for example, a blower duct 37, a cold air supply duct 38, a refrigerating cooler chamber 61, a refrigerating cooler 62, a refrigerating blower fan 64, and a chilling cold air supply port 65. The refrigerating blower fan 64 is disposed behind the vegetable chamber 82 along with the refrigerating chamber suction port 36 and the blower duct 37. The refrigerating blower fan 64 blows air to the refrigerating cooler 62. In the specification, “blowing air to the cooler” is not limited to a case in which a blower fan is disposed on the upstream side of the cooler in the air flow direction and blows air toward the cooler. In the specification, “blowing air toward the cooler” also includes a case in which a blower fan is disposed on the downstream side of the cooler in the air flow direction and ambient air is further fed to the downstream side so that air located on the upstream side of the cooler is moved toward the cooler. The blower duct 37 communicates with the refrigerating cooler chamber 61. The refrigerating chamber suction port 36 opens to, for example, the vegetable chamber 82.

In this configuration, when the refrigerating blower fan 64 is driven, air inside the vegetable chamber 82 is sucked from the refrigerating chamber suction port 36 toward the refrigerating blower fan 64 and the sucked air is blown out toward the blower duct 37. Air blown out toward the blower duct 37 contacts the refrigerating cooler chamber 61 to be cooled by exchanging heat. The cooled air (cold air) passes through the cold air supply duct 38 and is blown out from a plurality of refrigerating cold air supply ports 38a to the normal refrigerating chamber 81a. The cooled air (cold air) is ejected from the chilling cold air supply port 65 to the chilled chamber 81c. The cold air flowing into the normal refrigerating chamber 81a and the chilled chamber 81c flows to the vegetable chamber 82 through the front vent 94c and the rear vent 94b and is finally suctioned to the refrigerating blower fan 64 and circulated.

In this circulation process, air passing through the refrigerating cooler chamber 61 is cooled by the refrigerating cooler 62 to become cold air and the cold air is supplied to the normal refrigerating chamber 81a so that the normal refrigerating chamber 81a is cooled to a temperature in the refrigerating temperature zone. The cold air is supplied to the chilled chamber 81c so that the chilled chamber 81c is cooled to a temperature in the chilled temperature zone. Since the chilled chamber 81c is located at a position closer to the refrigerating cooler chamber 61 in relation to the normal refrigerating chamber 81a or the vegetable chamber 82, the chilled chamber 81c is kept in a chilled temperature zone (for example, 0 to 1° C.) which is lower than the refrigerating temperature zone (for example, 1 to 5° C.).

The second cooling mechanism 70 (the cooling mechanism of the refrigerating temperature zone) includes, for example, a freezing cooler chamber 71, a freezing cooler 72, and a freezing blower fan 76. The freezing cooler chamber 71 is provided on the back wall portion of the storage chamber (the ice-making chamber 83, the small freezing chamber 84, and the main freezing chamber 85) in the refrigerating temperature zone of the refrigerator 1. The freezing cooler 72 or a defrosting heater (not shown) is disposed in the freezing cooler chamber 71. The freezing blower fan 76 is disposed below the freezing cooler 72. A cold air outlet 77 is provided at the upper end portion of the front surface of the freezing cooler chamber 71. A freezing chamber suction port 78 is provided at the lower end portion of the front surface of the freezing cooler chamber 71. The cold air outlet 77 is an example of the “cold air inlet” through which cold air flows into the small freezing chamber 84 (the storage chamber 80). A member 79 forming the cold air outlet 77 is an example of the “housing interior structure component”.

When the freezing blower fan 76 is driven, cold air generated by the freezing cooler 72 is supplied from the cold air outlet 77 into the ice-making chamber 83, the small freezing chamber 84, and the main freezing chamber 85 and is returned from the freezing chamber suction port 78 into the freezing cooler chamber 71 and circulated. Accordingly, the ice-making chamber 83, the small freezing chamber 84, and the main freezing chamber 85 are cooled.

Here, the refrigerator 1 of the first embodiment includes a plurality of interior members such as the housing 10, the plurality of doors 20 (21 to 26), the plurality of shelves 30 (31 to 33), the plurality of containers 40 (41 to 47), and the ice-making water supply tank 510. At least part of at least one of the housing 10, the plurality of doors 20 (21 to 26), and the plurality of interior members (for example, the plurality of shelves 30 (31 to 33) or the plurality of containers 40 (41 to 47)) is formed of the specific heat-insulating material 209 containing aerogel, xerogel, or cryogel.

In the first embodiment, an example in which the window portion 112 is provided in the right refrigerating chamber door 22 among the plurality of doors 20 (21 to 26) will be described. However, the window portion 112 may be provided in a door other than the right refrigerating chamber door 22. The window portion 112 may be provided in one or more doors among the plurality of doors 20 (21 to 26). In the first embodiment, the right refrigerating chamber door 22 includes the window portion 112 through which an inside of the storage chamber (the refrigerating chamber 81) is visible from the outside of the refrigerator 1 and at least part of the window portion 112 is formed of the specific heat-insulating material 209.

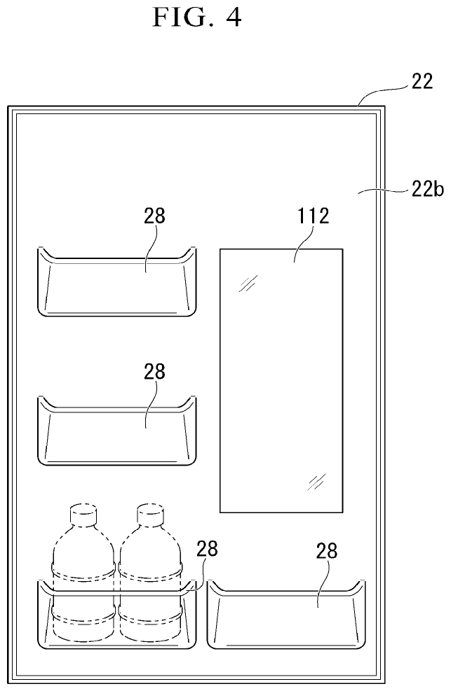

FIG. 4 is a rear view showing a back surface 22b of the right refrigerating chamber door 22. The right refrigerating chamber door 22 includes a front surface 22a (see FIG. 1) which faces the user standing in front of the refrigerator 1 and a back surface 22b which is exposed to the inside of the refrigerating chamber 81 in a closed state. The back surface 22b is provided with a plurality of pockets 28. In the back surface 22b, the pocket 28 is not provided in a portion overlapping the window portion 112 in the depth direction of the refrigerator 1.

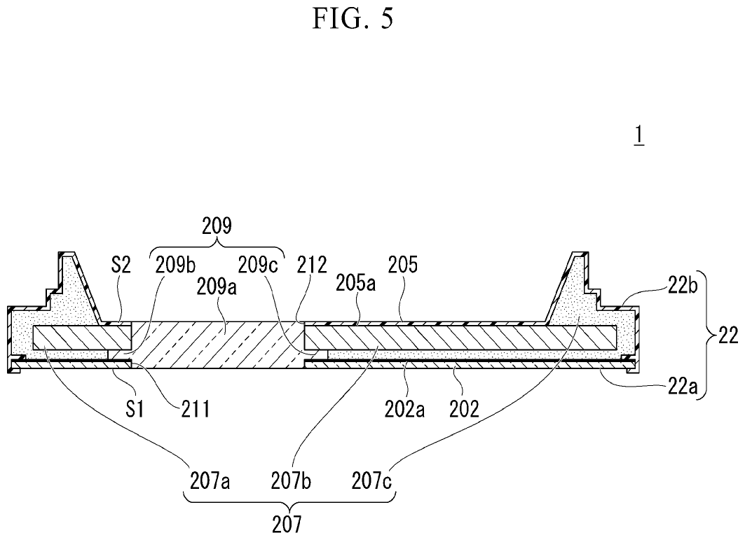

FIG. 5 is a cross-sectional view of the right refrigerating chamber door 22 taken along a line F5-F5 of FIG. 1. The right refrigerating chamber door 22 includes, for example, a front plate 202, an inner surface plate 205, a normal heat-insulating material 207, and the specific heat-insulating material 209.

The front plate 202 is a decorative plate that appears in the appearance of the refrigerator 1. The front plate 202 forms a front surface S1 of the right refrigerating chamber door 22. The front plate 202 is formed of, for example, a transparent member such as synthetic resin or glass plate. In the first embodiment, the front plate 202 is formed of a glass plate. For example, the front plate 202 is formed in a flat plate shape over substantially the entire area of the right refrigerating chamber door 22 in the up and down direction and the left and right direction. A shatterproof sheet 202a is adhered to the back surface of the front plate 202. The front plate 202 is provided with an opening portion 211.

The inner surface plate 205 is a decorative plate which is exposed to the inside of the refrigerating chamber 81. The inner surface plate 205 forms a back surface S2 of the right refrigerating chamber door 22. In the first embodiment, the inner surface plate 205 is formed of, for example, a member such as synthetic resin. The inner surface plate 205 includes a flat plate portion 205a extending substantially parallel to the front plate 202. An opening portion 212 is provided at a position corresponding to the opening portion 211 of the front plate 202 of the flat plate portion 205a.

The normal heat-insulating material 207 is provided between the front plate 202 and the inner surface plate 205. In the first embodiment, the normal heat-insulating material 207 includes, for example, a first vacuum heat-insulating material 207a, a second vacuum heat-insulating material 207b, and a foamed heat-insulating material 207c. The first vacuum heat-insulating material 207a and the second vacuum heat-insulating material 207b are formed in a flat plate shape.

The first vacuum heat-insulating material 207a is located on the left side of the specific heat-insulating material 209 and extends in the up and down direction. The first vacuum heat-insulating material 207a is located between the front plate 202 and the inner surface plate 205. Part of the first vacuum heat-insulating material 207a is fixed to the inner surface plate 205 by a double-sided tape or adhesive.

The second vacuum heat-insulating material 207b is located on the right side of the specific heat-insulating material 209 and extends in the up and down direction. The second vacuum heat-insulating material 207b is located between the front plate 202 and the inner surface plate 205. Part of the second vacuum heat-insulating material 207b is fixed to the inner surface plate 205 by a double-sided tape or adhesive.

The foamed heat-insulating material 207c is, for example, urethane foam. The foamed heat-insulating material 207c is filled between the front plate 202 and the first vacuum heat-insulating material 207a, between the inner surface plate 205 and the first vacuum heat-insulating material 207a, between the front plate 202 and the second vacuum heat-insulating material 207b, and between the inner surface plate 205 and the second vacuum heat-insulating material 207b.

In the description above, an example in which both the first vacuum heat-insulating material 207a and the second vacuum heat-insulating material 207b are provided as the normal heat-insulating material 207 is shown. Any one of the first vacuum heat-insulating material 207a and the second vacuum heat-insulating material 207b may not be provided. Alternatively, both the first vacuum heat-insulating material 207a and the second vacuum heat-insulating material 207b may not be provided. In this case, the foamed heat-insulating material 207c is filled between the front plate 202 and the inner surface plate 205.

The specific heat-insulating material 209 is a heat-insulating material containing aerogel, xerogel, or cryogel. “Containing aerogel, xerogel, or cryogel” means “containing one or more of aerogel, xerogel, or cryogel”. Aerogel, xerogel, and cryogel are low-density structures (dry gels), respectively. “Aerogel” is, for example, a porous substance in which the solvent contained in the gel is replaced with a gas by supercritical drying. “Xerogel” is a porous substance in which the solvent contained in the gel is replaced with a gas by evaporation drying. “Cryogel” is a porous substance in which the solvent contained in the gel is replaced with a gas by freeze-drying.

Some aerogels can be dried without using supercritical drying, for example, by introducing a specific element. The “aerogel” mentioned in the specification also includes such an aerogel. That is, “aerogel” mentioned in the specification is not limited to those manufactured using supercritical drying and broadly means various materials distributed as “aerogel”. As aerogel that does not require supercritical drying, for example, organic-inorganic hybrid aerogel in which an organic chain such as a methyl group is introduced into the molecular network of silicon dioxide is known and there are PMSQ (CH₃SiO_{1.5}) aerogels and the like. However, these are just examples.

Aerogel, xerogel, and cryogel are ultra-low density dry porous bodies with a large number of fine pores and extremely high porosity (porosity of 90% or more, preferably 95% or more). The density of the dry porous body is, for example, 150 mg/cm³ or less. Aerogel, xerogel, and cryogel have, for example, a structure in which silicon dioxide and the like are bonded in a ball chain shape, and have a large number of nanometer-level voids. The nanometer-level voids are, for example, 100 nm or less, preferably 2 nm to 50 nm. Since aerogel, xerogel, and cryogel have nanometer-level pores and a lattice structure, the mean free path of gas molecules can be reduced, the heat conduction between gas molecules is very small even at normal pressure, and the thermal conductivity is very small. For example, aerogel, xerogel, and cryogel have fine voids that are smaller than the mean free path of air.

As aerogel, xerogel, and cryogel, inorganic aerogel, inorganic xerogel, and inorganic cryogel made of metal oxides such as silicon, aluminum, iron, copper, zirconium, hafnium, magnesium, and yttrium may be used or, for example, silica aerogel, silica xerogel, and silica cryogel containing silicon dioxide may be used. These have a structure in which silica (SiO₂) fine particles having a diameter of 10 nm to 20 nm are connected and have pores having a width of several tens of nanometers. Since aerogel, xerogel, and cryogel have low density, the heat conduction in solid parts is extremely low. Further, since the movement of air inside the pores is restricted, aerogel, xerogel, and cryogel have extremely low thermal conductivity (0.012 to 0.02 W/m·K). Since the silica fine particles and pores are smaller than the wavelength of visible light and do not scatter visible light, the light transmission is high. As a material of the aerogel, xerogel, and cryogel may be carbon or the like. In the first embodiment, a material having light transmission (for example, a transparent material) is adopted as the material of aerogel, xerogel, and cryogel.

Aerogel, xerogel, and cryogel can have arbitrary properties (for example, elasticity and flexibility) by selecting the material. High elasticity or flexibility can be imparted by selecting, for example, polypropylene as the material for aerogel, xerogel, and cryogel.

Each of aerogel, xerogel, and cryogel may form the specific heat-insulating material 209. Alternatively, each of aerogel, xerogel, and cryogel may form the specific heat-insulating material 209 which is a composite heat-insulating material by immersing another material (for example, a fiber structure) in the state of a precursor. Such a fiber structure is a reinforcing material for reinforcing a dry gel or a member acting as a support for supporting a dry gel. As the fiber structure, a flexible woven fabric, knitted fabric, non-woven fabric, and the like are used to obtain a flexible composite heat-insulating material. As the fiber structure, a felt or blanket-like structure is more preferably used. As the material of the fiber structure, inorganic fibers such as glass fibers can also be used in addition to organic fibers such as polyester fibers. In the first embodiment, a material having light transmission (for example, a transparent material) is adopted for the fiber structure as well.

The fiber structure is, for example, a natural polymer chitosan. The specific heat-insulating material 209 contains a three-dimensional network structure of hydrophobicized fine chitosan fibers and has an ultra-high porosity (96 to 97% of the volume is void). Hydrophobization enhances the moisture resistance which is a problem with materials made of polysaccharide nanofibers and has water repellency while maintaining the homogeneous nanostructure of hydrophilic chitosan aerogel.

The specific heat-insulating material 209 may be, for example, a heat-insulating material in which a polypropylene foam and one selected from silica aerogel, xerogel, and cryogel are composited.

The thermal conductivity of the specific heat-insulating material 209 is higher than the thermal conductivity of the vacuum heat-insulating material, but is lower than the thermal conductivity of the foamed heat-insulating material such as urethane foam. That is, the heat-insulating property of the specific heat-insulating material 209 is not as good as that of the vacuum heat-insulating material, but is superior to the heat-insulating property of the foamed heat-insulating material. The thermal conductivity of the specific heat-insulating material 209 is, for example, 0.010 W/m·K to 0.015 W/m·K. The thermal conductivity of the vacuum heat-insulating material is, for example, 0.003 W/m·K to 0.005 W/m·K. The thermal conductivity of the foamed heat-insulating material is, for example, 0.020 W/m·K to 0.022 W/m·K. These numerical values are merely examples.

When the specific heat-insulating material 209 has flexibility, the flexibility (bendability) of the specific heat-insulating material 209 is, for example, higher than the flexibility of the vacuum heat-insulating material and is higher than the flexibility of the foamed heat-insulating material. When the specific heat-insulating material 209 has elasticity, the elasticity of the specific heat-insulating material 209 is, for example, higher than the elasticity (substantially close to zero) of the vacuum heat-insulating material and is higher than the elasticity (substantially close to zero) of the foamed heat-insulating material.

In the first embodiment, the specific heat-insulating material 209 is transparent. Hereinafter, for convenience of description, the specific heat-insulating material 209 is referred to as the transparent heat-insulating material 209.

The transparent heat-insulating material 209 includes, for example, a main body portion 209a and a plurality of support portions 209b and 209c. The main body portion 209a is located between the first vacuum heat-insulating material 207a and the second vacuum heat-insulating material 207b in the width direction of the refrigerator 1. The front end portion of the main body portion 209a is fitted into the opening portion 211 of the front plate 202. The front surface of the main body portion 209a is flush with the front surface of the front plate 202. The rear end portion of the main body portion 209a is fitted into the opening portion 212 of the inner surface plate 205. The rear surface of the main body portion 209a is flush with the rear surface of the inner surface plate 205.

Each of the support portions 209b and 209c is located between the front plate 202 and the inner surface plate 205 in the depth direction of the refrigerator 1. For example, the support portion 209b is sandwiched between the front plate 202 and the first vacuum heat-insulating material 207a and the support portion 209c is sandwiched between the front plate 202 and the second vacuum heat-insulating material 207b. Accordingly, the position of each of the support portions 209b and 209c inside the right refrigerating chamber door 22 is regulated. Gaps existing between the vacuum heat-insulating materials 207a and 207b and the front plate 202 on the side of the support portions 209b and 209c are filled with the foamed heat-insulating material 207c.

For example, a receiving member may be interposed between the first vacuum heat-insulating material 207a and the support portion 209b, between the second vacuum heat-insulating material 207b and the support portion 209c, and between the front plate 202 and each of the support portions 209b and 209c. The receiving member is formed of, for example, a member such as synthetic resin. The fixing of the transparent heat-insulating material 209 is not limited to the above-described configuration and the transparent heat-insulating material 209 may be fixed to the opening portion 211 in such a manner that a fastening member such as a bolt or a nut engages with a screw insertion hole.

Among the plurality of doors 20, the doors 20 (the vegetable chamber door 23, the ice-making chamber door 24, the small freezing chamber door 25, and the main freezing chamber door 26) other than the right refrigerating chamber door 22 may have the same configuration and the transparent heat-insulating material 209 may not be provided.

According to the above-described configuration, since the inside of the refrigerator 1 is easily visually recognized without opening the door while ensuring the heat-insulating property of the refrigerator 1, the convenience of the refrigerator 1 is improved.

(First Modified Example of First Embodiment)

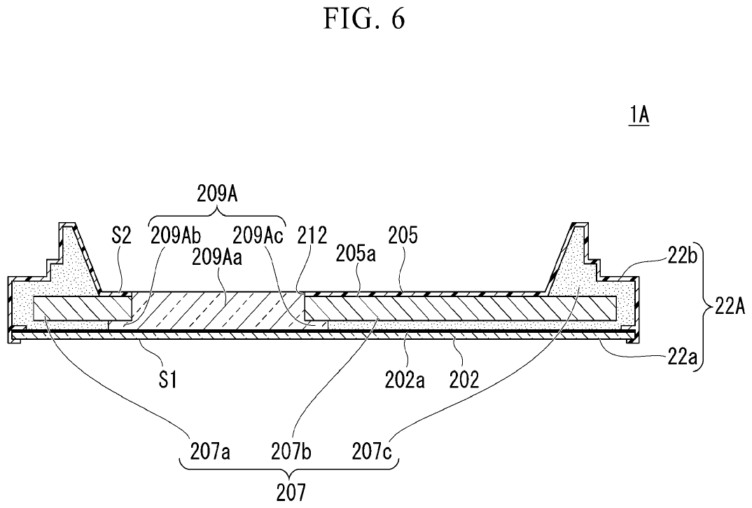

FIG. 6 is a cross-sectional view of a right refrigerating chamber door 22A of a refrigerator 1A of a first modified example of the first embodiment. A right refrigerating chamber door 22A of the first modified example includes, for example, a front plate 202A, the inner surface plate 205, the normal heat-insulating material 207, and a transparent heat-insulating material 209A.

The front plate 202A has the same configuration as that of the front plate 202 of the refrigerator 1 of the first embodiment, but the front plate 202A does not include the opening portion 211 like the front plate 202. The front plate 202A has a plate shape over substantially the entire width of the right refrigerating chamber door 22A. The front plate 202A is located on the front side of the transparent heat-insulating material 209A in the entire width of the transparent heat-insulating material 209A.

The transparent heat-insulating material 209A of the right refrigerating chamber door 22A of this modified example is disposed to be in contact with the back surface of the front plate 202A through the shatterproof sheet 202a. In this modified example, the shatterproof sheet 202a is formed of a transparent member.

The transparent heat-insulating material 209A includes a main body portion 209Aa, a support portion 209Ab, and a support portion 209Ac. The main body portion 209Aa includes a portion which is located between two vacuum heat-insulating materials 207a and 207b while transmitting light. In the support portions 209Ab and 209Ac, the main body portion 209Aa which protrudes from the side portion of the main body portion 209Aa in the width direction of the refrigerator 1 is located behind the front plate 202A and is regulated to move forward by the front plate 202A. As shown in the drawing, the support portions 209Ab and 209Ac are sandwiched between the front plate 202 and the normal heat-insulating material 207 (for example, the front plate 202 and the vacuum heat-insulating materials 207a and 207b) so that positions of the support portions 209Ab and 209Ac are regulated in the right refrigerating chamber door 22A. The surfaces of the main body portion 209Aa and the support portions 209Ab and 209Ac of the transparent heat-insulating material 209A in contact with the front plate 202A are located on the same plane. The right refrigerating chamber door 22A of the first modified example has the same configuration as that of the right refrigerating chamber door 22 of the first embodiment except for the configuration above.

Among the plurality of doors 20, the doors 20 (the vegetable chamber door 23, the ice-making chamber door 24, the small freezing chamber door 25, and the main freezing chamber door 26) other than the right refrigerating chamber door 22 may have the same configuration and the transparent heat-insulating material 209A does not have to be provided.

(Second Modified Example of First Embodiment)

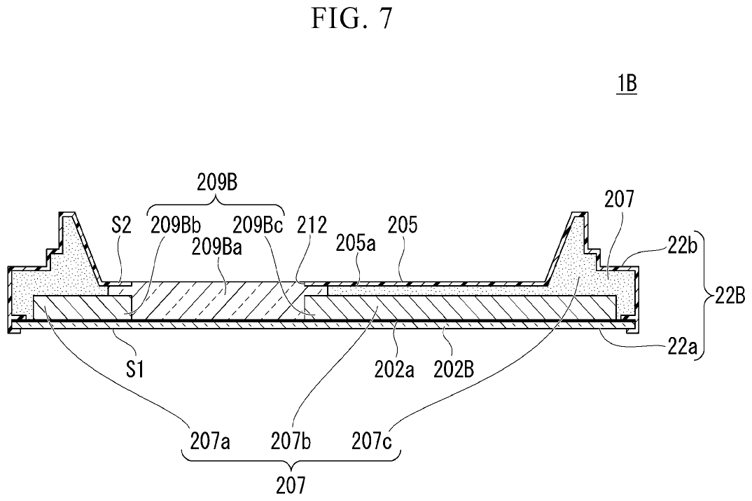

FIG. 7 is a cross-sectional view of a right refrigerating chamber door 22B of a refrigerator 1B of a second modified example of the first embodiment. The right refrigerating chamber door 22B of the refrigerator 1B of the second modified example includes, for example, a front plate 202B, the inner surface plate 205, the normal heat-insulating material 207, and a transparent heat-insulating material 209B.

The front plate 202B has, for example, the same configuration as the front plate 202A of the first modified example. The transparent heat-insulating material 209B of the right refrigerating chamber door 22B of the second modified example is disposed to be in contact with the back surface of the front plate 202B through the shatterproof sheet 202a. In this modified example, the shatterproof sheet 202a is formed of a transparent member.

The transparent heat-insulating material 209B includes a main body portion 209Ba which is located between two vacuum heat-insulating materials 207a and 207b while transmitting light and a support portion 209Bb and a support portion 209Bc which protrude from the side portion of the main body portion 209Ba in the width direction of the refrigerator 1. As shown in the drawing, each of the support portions 209Bb and 209Bc is sandwiched between the inner surface plate 205 and the normal heat-insulating material 207 (for example, sandwiched between the inner surface plate 205 and the vacuum heat-insulating materials 207a and 207b) so that the position inside the right refrigerating chamber door 22B is regulated. Each of the support portions 209Bb and 209Bc is provided at the side portion of the main body portion 209Ba to be in contact with the front surface of the inner surface plate 205B. The right refrigerating chamber door 22B of the second modified example has the same configuration as that of the right refrigerating chamber door 22 of the first embodiment except for the above-described configuration.

Among the plurality of doors 20, the doors 20 (the vegetable chamber door 23, the ice-making chamber door 24, the small freezing chamber door 25, and the main freezing chamber door 26) other than the right refrigerating chamber door 22 may have the same configuration and the transparent heat-insulating material 209B does not have to be provided.

### Second Embodiment

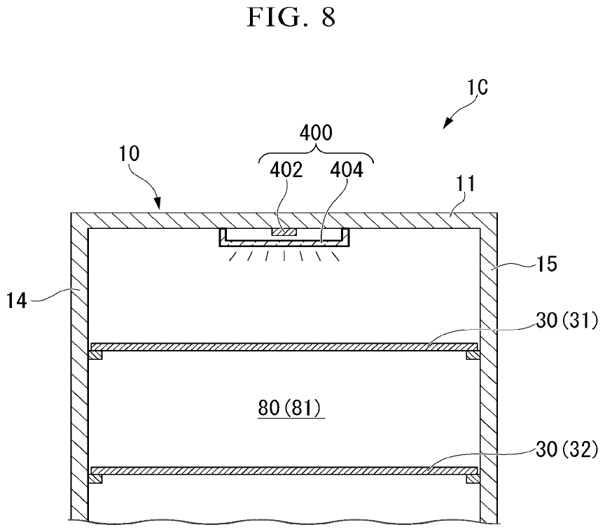

FIG. 8 is a cross-sectional view showing a lighting unit 400 of a refrigerator 1C of a second embodiment and is a diagram when the user standing in front of the refrigerator 1C opens the door 22 and sees the refrigerating chamber 81. The refrigerator 1C of the second embodiment has the same configuration as that of the refrigerator 1 of the first embodiment except that the lighting unit 400 is provided. The lighting unit 400 includes, for example, a light emitter 402 which illuminates the inside of the refrigerating chamber 81 and a lighting cover 404 which is disposed inside the refrigerating chamber 81 and covers the light emitter 402. For example, the lighting cover 404 is a cover that diffuses the light emitted from the light emitter 402 into the refrigerating chamber 81. At least part of the lighting cover 404 is formed of the specific heat-insulating material 209. In the second embodiment, the entire lighting cover 404 is formed of the specific heat-insulating material 209. In the second embodiment, the specific heat-insulating material 209 is, for example, translucent. The lighting cover 404 is an example of the “interior member”.

According to the refrigerator 1C of the second embodiment, it is possible to suppress the refrigerating chamber 81 from being affected by the heat generated in the light emitter 402 while transmitting the light of the light emitter 402 using the lighting cover 404.

The lighting cover 404 may have the following configuration instead of being formed of the specific heat-insulating material 209. For example, the lighting cover 404 may include a cover body and a heat-insulating sheet. The cover body is formed of synthetic resin or glass that have light transmission and covers the light emitter 402. The heat-insulating sheet is formed of the specific heat-insulating material 209 and is attached to the inner surface or the outer surface of the cover body.

### Third Embodiment

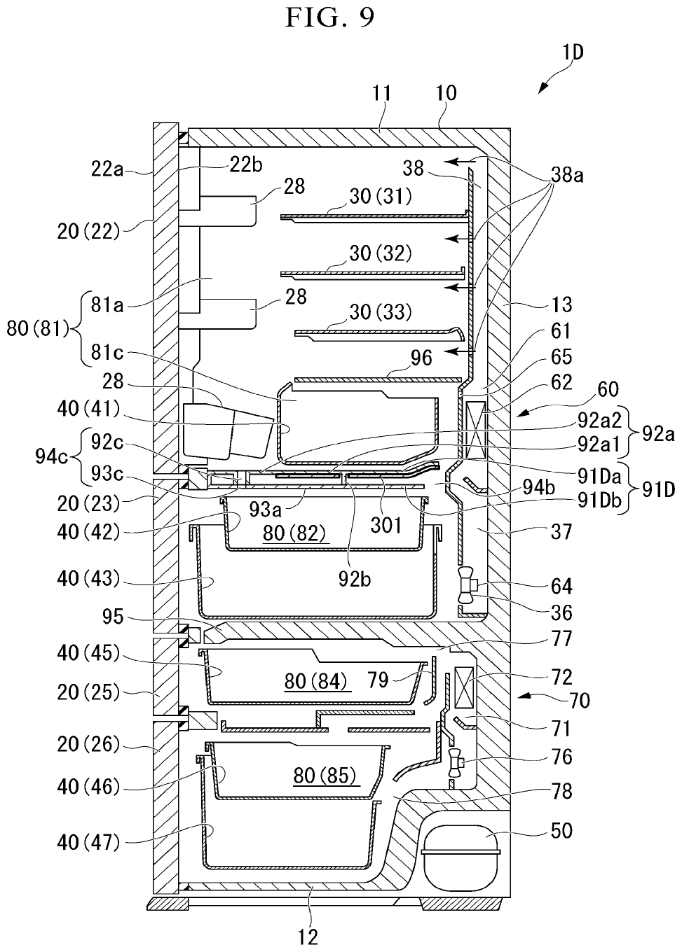

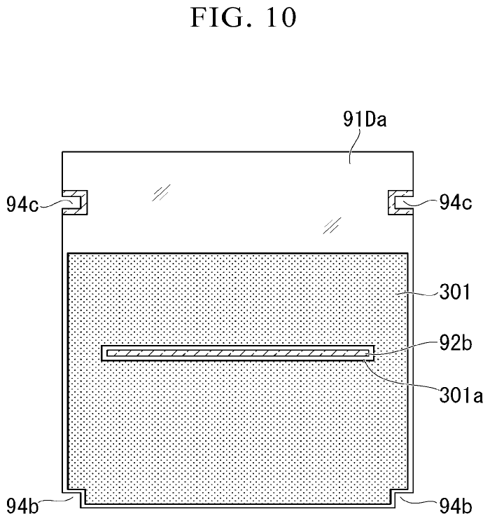

FIG. 9 is a cross-sectional view showing a refrigerator 1D of a third embodiment. FIG. 10 is a bottom view of a first partition wall upper member 91Da of a first partition wall 91D of the third embodiment as viewed from below. The refrigerator 1D of the third embodiment has the same configuration as that of the refrigerator 1 of the first embodiment, but the refrigerator 1D is different from the refrigerator 1 of the first embodiment in that the first partition wall 91D is provided instead of the first partition wall 91. The first partition wall 91D is an example of the “partition portion”.

The housing 10 includes the plurality of storage chambers 80 (the refrigerating chamber 81 and the vegetable chamber 82) and the partition portion (the first partition wall 91D) provided between the plurality of storage chambers 80 and at least part of the partition portion (the first partition wall 91D) is formed of the specific heat-insulating material 209.

As shown in the drawing, the first partition wall 91D includes, for example, the first partition wall upper member 91Da, the first partition wall lower member 91Db, and a first partition wall heat-insulating sheet 301.

The first partition wall upper member 91Da includes a plate portion 92a extending horizontally, a rib 92b, and one or more cold air guide portions 92c. The plate portion 92a extends horizontally and forms the bottom portion of the ice-making water supply tank chamber 81b and the bottom portion of the chilled chamber 81c.

The plate portion 92a includes a first region 92a1 which is located below the chilled chamber 81c and a second region 92a2 which is located outside the lower portion of the chilled chamber 81c. The second region 92a2 is located on the front side of, for example, the chilled chamber 81c. The rib 92b is a plate-shaped protrusion portion which extends in the width direction of the refrigerator 1 and protrudes downward from the lower surface of the plate portion 92a. A lower end portion of the rib 92b comes into contact with the upper surface of the first partition wall lower member 91Db. For example, the rib 92b is provided in the first region 92a1 of the plate portion 92a.

The cold air guide portion 92c protrudes downward from the plate portion 92a and comes into contact with the upper surface of the first partition wall lower member 91Db. The cold air guide portion 92c includes a through-hole through which cold air flows. As shown in FIG. 9, in the third embodiment, the cold air guide portion 92c is a notch portion which forms a through-hole between the left wall 14 and the right wall 15 of the housing 10 and the first partition wall upper member 91Da so that cold air flows therethrough.

The first partition wall lower member 91Db includes a plate portion 93a which extends horizontally and one or more cold air guide portions 93c. The plate portion 93a extends horizontally and forms the ceiling of the vegetable chamber 82. The plate portion 93a is located below the first partition wall upper member 91Da and a space exists between the plate portion and the first partition wall upper member 91Da. The cold air guide portion 93c is provided at a position corresponding to the cold air guide portion 92c. The cold air guide portion 93c includes a through-hole through which cold air flows. In the third embodiment, the cold air guide portion 93c is a notch portion which forms a through-hole between the left wall 14 and the right wall 15 of the housing 10 and the first partition wall lower member 91Db so that cold air flows therethrough.

Each of the first partition wall upper member 91Da and the first partition wall lower member 91Db is, for example, a thin plate-shaped member that is formed of a member such as synthetic resin or glass having light transmission.

The first partition wall heat-insulating sheet 301 is formed of, for example, the above-described specific heat-insulating material 209. The first partition wall heat-insulating sheet 301 is adhered to the lower surface of the first region 92a1 of the plate portion 92a of the first partition wall upper member 91Da by, for example, a double-sided tape or adhesive having light transmission. The first partition wall heat-insulating sheet 301 is not provided in the second region 92a2 of the plate portion 92a of the first partition wall upper member 91Da.

For example, as shown in the drawing, the first partition wall heat-insulating sheet 301 includes a hole portion 301a which is elongated in the width direction and corresponds to the rib 92b. In a state in which the first partition wall heat-insulating sheet 301 is adhered to the lower surface of the first partition wall upper member 91Da, the rib 92b penetrates the hole portion 301a downward. The first partition wall upper member 91Da allowing the first partition wall heat-insulating sheet 301 to be adhered to the lower surface thereof is superimposed on the first partition wall lower member 91Db and both engage with each other by engagement means (not shown) to form the first partition wall 91D.

As described above, the front vent 94c is formed by a pair of cold air guide portions 92c and 93c. The front vent 94c is a through-hole penetrating the first partition wall upper member 91Da and the first partition wall lower member 91Db. The refrigerating chamber 81 communicates with the vegetable chamber 82 through the front vents 94c. Similarly, one or more corners on the inner side of the first partition wall 91D in the depth direction are formed in a notch shape to form the rear vent 94b. The rear vent 94b is a through-hole penetrating the first partition wall upper member 91Da and the first partition wall lower member 91Db. The refrigerating chamber 81 communicates with the vegetable chamber 82 through the rear vent 94b. The first partition wall 91D may include at least one or more of the front vent 94c and the rear vent 94b. The rear vent 94b is an example of the “cold air inlet” allowing cold air to flow into the vegetable chamber 82 (the storage chamber 80). The first partition wall 91D is an example of the “housing interior structure component”.

According to the refrigerator 1D of the third embodiment, the first partition wall heat-insulating sheet 301 is provided right below the chilled chamber 81c (the first region 92a1 of the plate portion 92a). Therefore, a temperature of the chilled chamber 81c kept in the chilled temperature zone (for example, 0 to 1° C.), which is a lower temperature than that of the refrigeration temperature zone (for example, 1 to 5° C.), is inhibited from being transmitted to the vegetable chamber 82. That is, according to the refrigerator 1 of the first embodiment, occurrence of a locally overcooled portion in the vegetable chamber 82 due to the temperature of the chilled chamber 81c is capable of being inhibited.

For example, the first partition wall heat-insulating sheet 301 is not provided in the second region 92a2 of the plate portion 92a. For this reason, since the vegetable chamber 82 can be efficiently cooled by the temperature of the normal refrigerating chamber 81a as compared with a case in which the normal refrigerating chamber 81a and the vegetable chamber 82 are insulated from each other, it is possible to improve energy saving performance.

According to the refrigerator 1D of the third embodiment, the user can see the vegetable chamber 82 from the refrigerating chamber 81 through the first partition wall 91D having light transmission in addition to the above-described effect. Accordingly, the user can easily visually recognize the stored items of the refrigerator 1D and the convenience of the refrigerator 1D is improved. The aesthetics of the refrigerator 1D can be improved.

The first partition wall heat-insulating sheet 301 may be attached to the upper surface of the first partition wall upper member 91Da, may be attached to the upper surface of the first partition wall lower member 91Db, and may be attached to the lower surface of the first partition wall lower member 91Db.

(Modified Example of Third Embodiment)

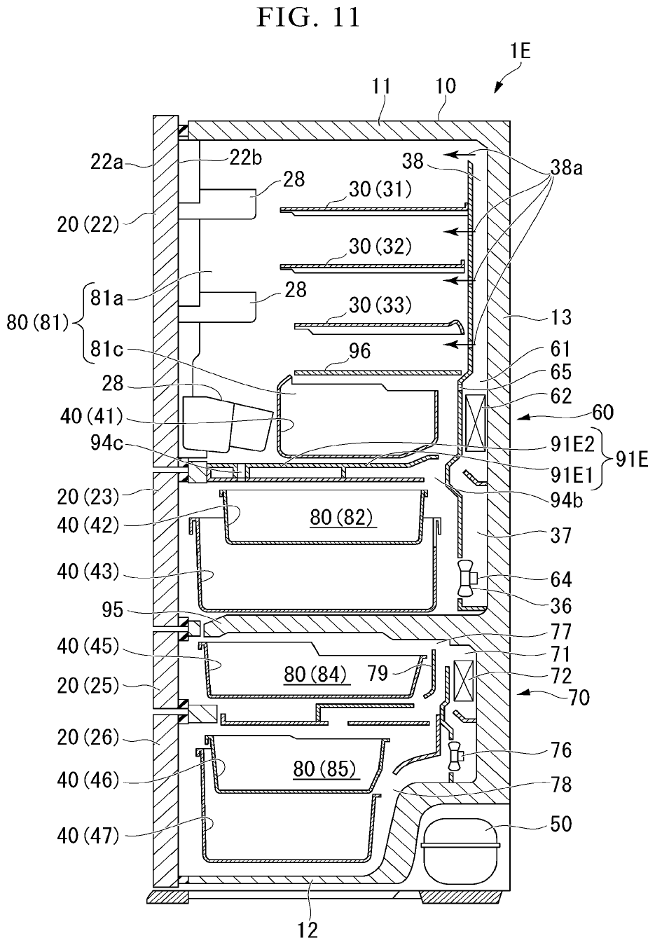

FIG. 11 is a cross-sectional view showing a refrigerator 1E of a modified example of the third embodiment. The refrigerator 1E of the modified example of the third embodiment has the same configuration as that of the refrigerator 1D of the third embodiment, but is different from the refrigerator 1D of the third embodiment in that a first partition wall 91E is provided instead of the first partition wall 91D.

The first partition wall 91E includes a first region 91E1 which is located below the chilled chamber 81c and a second region 91E2 which is located outside the lower portion of the chilled chamber 81c. The first partition wall 91E is located, for example, on the front side of the chilled chamber 81c. In the modified example of the third embodiment, both the first region 91E1 and the second region 91E2 are formed of the specific heat-insulating material 209.

Thus, even when, the first partition wall 91E has a heat-insulating property even if the first partition wall heat-insulating sheet 301 is not attached to the first partition wall 91E. The first partition wall 91E is an example of the “partition portion”.

According to the refrigerator 1E of the modified example of the third embodiment, it is possible to obtain the same effect as that of the refrigerator 1D of the third embodiment (the heat insulation from the chilled chamber 81c and the visibility). In addition, according to the refrigerator 1 E of the modified example of the third embodiment, it is possible to simplify the structure of the first partition wall 91E and simplify the manufacturing process.

Instead of the above-described configuration, only the first region 91E1 may be formed of the specific heat-insulating material 209 and the second region 91E2 may be formed of transparent synthetic resin or glass plate. In this case, since the vegetable chamber 82 can be efficiently cooled by the temperature of the normal refrigerating chamber 81a through the second region 91E2, it is possible to improve energy saving performance.

### Fourth Embodiment

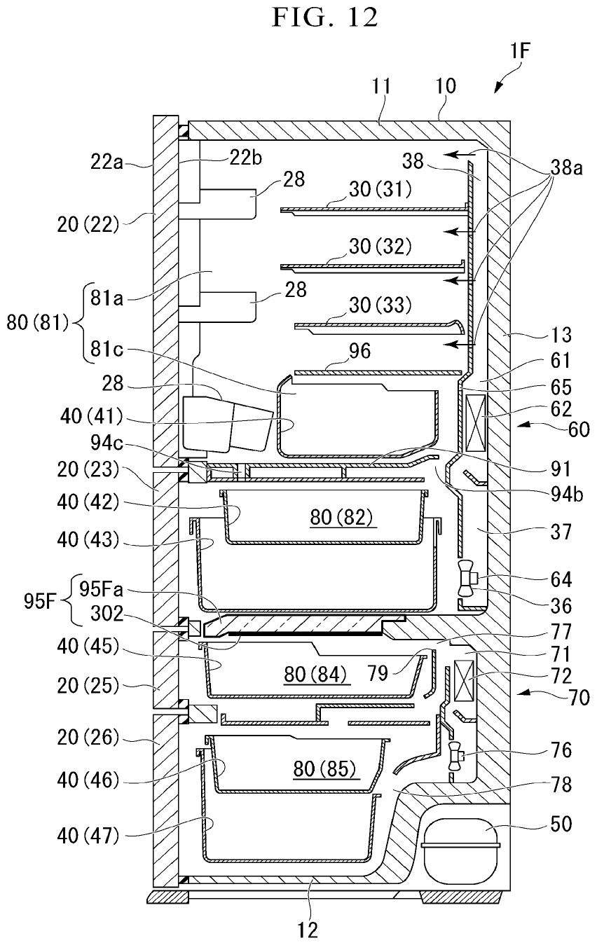

FIG. 12 is a cross-sectional view showing a refrigerator 1F of a fourth embodiment. The refrigerator 1F of the fourth embodiment has the same configuration as that of the refrigerator 1 of the first embodiment, but the refrigerator 1F is different from the refrigerator 1 of the first embodiment in that a second partition wall 95F is provided instead of the second partition wall 95. The second partition wall 95F includes a second partition wall main body 95Fa and a second partition wall heat-insulating sheet 302.

The second partition wall main body 95Fa is formed of, for example, a member such as synthetic resin or glass having light transmission. The second partition wall main body 95Fa is provided between the vegetable chamber 82 and the ice-making chamber and the small freezing chamber 84 and partitions the vegetable chamber 82 from the ice-making chamber 83 and the small freezing chamber 84. The second partition wall heat-insulating sheet 302 is formed of, for example, the specific heat-insulating material 209. The second partition wall heat-insulating sheet 302 is adhered to the lower surface of the second partition wall main body 95Fa by a double-sided tape or adhesive having light transmission. For example, the second partition wall heat-insulating sheet 302 has a size covering substantially the entire region of the lower surface of the second partition wall main body 95Fa. The second partition wall heat-insulating sheet 302 and the second partition wall main body 95Fa constitute an example of the “partition portion”.

According to the refrigerator 1F of the fourth embodiment, the user can see the ice-making chamber 83 and the small freezing chamber 84 from the vegetable chamber 82 through the second partition wall 95F having light transmission. Accordingly, the user can easily visually recognize the stored items of the refrigerator 1F and the convenience of the refrigerator 1D is improved. The aesthetics of the refrigerator 1F can be improved.

The second partition wall heat-insulating sheet 302 may be adhered to the upper surface of the second partition wall main body 95Fa instead of being adhered to the lower surface of the second partition wall main body 95Fa.

(Modified Example of Fourth Embodiment)

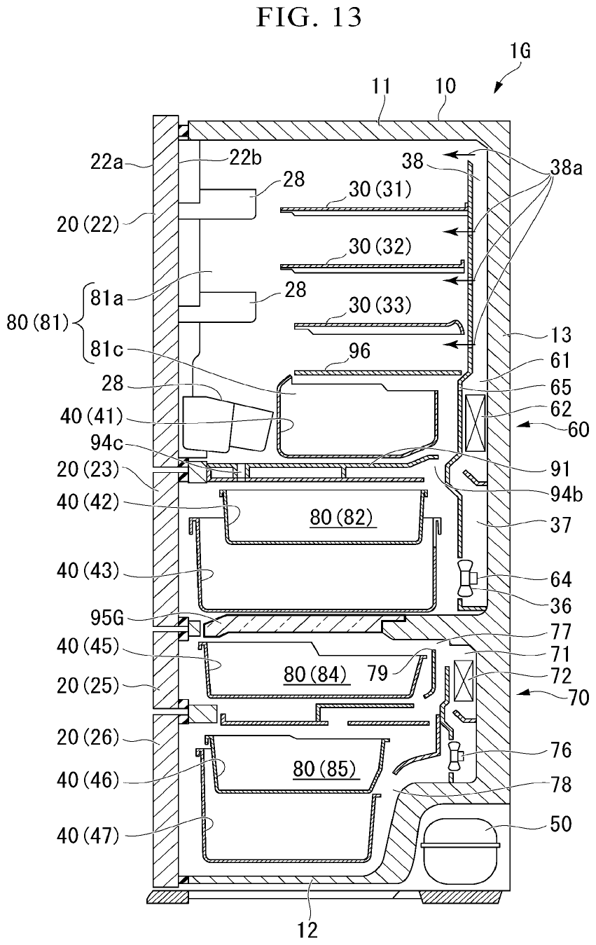

FIG. 13 is a cross-sectional view showing a refrigerator 1G of a modified example of the fourth embodiment. The refrigerator 1G of the modified example of the fourth embodiment has the same configuration as that of the refrigerator 1F of the fourth embodiment, but is different from the refrigerator 1F of the fourth embodiment in that a second partition wall 95G is provided instead of the second partition wall 95F. The second partition wall 95G is formed of the specific heat-insulating material 209. Thus, the second partition wall 95G has a heat-insulating property even when the second partition wall heat-insulating sheet 302 is not adhered thereto. The second partition wall 95G is an example of the “partition portion”.

According to the refrigerator 1G of the modified example of the fourth embodiment, it is possible to obtain the same effect as that of the refrigerator 1F of the fourth embodiment. In addition, according to the refrigerator 1G of the modified example of the fourth embodiment, it is possible to simplify the structure of the second partition wall 95G and simplify the manufacturing process.

### Fifth Embodiment

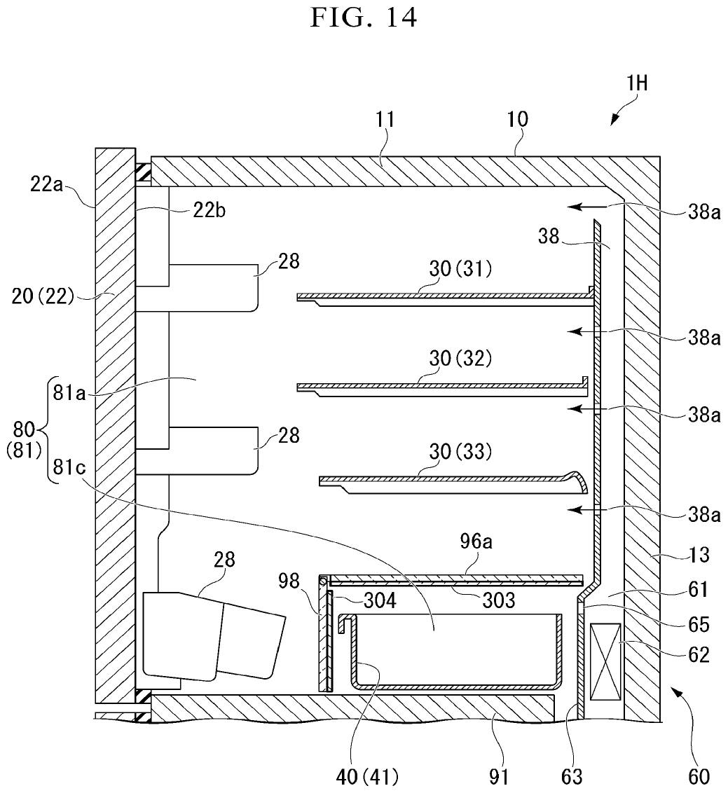

FIG. 14 is a cross-sectional view showing a refrigerator 1H of a fifth embodiment. The refrigerator 1H of the fifth embodiment has the same configuration as that of the refrigerator 1 of the first embodiment, but the refrigerator 1H of the fifth embodiment is different from the refrigerator 1 of the first embodiment in that a chilled chamber upper surface partition portion 96a is provided instead of the chilled chamber upper surface partition portion 96 and a chilled chamber lid 98 is provided.

The refrigerator 1H of the fifth embodiment includes the chilled case 41, the chilled chamber upper surface partition portion 96a, the chilled chamber lid 98, a third partition wall heat-insulating sheet 303, and a fourth partition wall heat-insulating sheet 304.

The chilled chamber upper surface partition portion 96a extends in a substantially horizontal direction between the normal refrigerating chamber 81a and the chilled chamber 81c and forms the ceiling portion of the chilled chamber 81c. The chilled chamber lid 98 is located on the front side of the chilled chamber 81c and is rotatably connected to, for example, the front upper end portion of the chilled chamber upper surface partition portion 96a so that the chilled chamber 81 c is closed so as to be openable. The chilled chamber lid 98 may be integrally formed with the chilled case 41 instead of being rotatably connected to the chilled chamber upper surface partition portion 96a and may be movable toward the front side of the refrigerator 1 together with the chilled case 41.

The chilled chamber 81c is partitioned from the normal refrigerating chamber 81a by the chilled chamber upper surface partition portion 96a and the chilled chamber lid 98. The chilled case 41 is provided inside the chilled chamber 81c. The chilled case 41 is provided to be taken in and out.

The chilled chamber upper surface partition portion 96a and the chilled chamber lid 98 are formed of, for example, a member such as synthetic resin or glass having light transmission. The third partition wall heat-insulating sheet 303 is formed of, for example, the specific heat-insulating material 209. The third partition wall heat-insulating sheet 303 is adhered to the lower surface of the chilled chamber upper surface partition portion 96a by a double-sided tape or adhesive having light transmission. For example, the third partition wall heat-insulating sheet 303 has a size covering substantially the entire region of the lower surface of the chilled chamber upper surface partition portion 96a.

Similarly, the fourth partition wall heat-insulating sheet 304 is formed of, for example, the specific heat-insulating material 209. The fourth partition wall heat-insulating sheet 304 is adhered to an inner surface of the chilled chamber lid 98 (a surface exposed to the inside of the chilled chamber 81c) by a double-sided tape or adhesive having light transmission. For example, the fourth partition wall heat-insulating sheet 304 has a size covering substantially the entire region of the inner surface of the chilled chamber lid 98.

The chilled chamber upper surface partition portion 96a, the chilled chamber lid 98, the third partition wall heat-insulating sheet 303, and the fourth partition wall heat-insulating sheet 304 constitute an example of the “partition member”. The chilled chamber upper surface partition portion 96a and the third partition wall heat-insulating sheet 303 constitute an example of the “plate portion forming the ceiling portion of the second storage portion”. The chilled chamber lid 98 and the fourth partition wall heat-insulating sheet 304 constitute an example of the “lid closing the second storage portion configured to open and close”.

According to the refrigerator 1H of the fifth embodiment, the user can see the inside of the chilled chamber 81c through the chilled chamber upper surface partition portion 96a, the third partition wall heat-insulating sheet 303, the chilled chamber lid 98, and the fourth partition wall heat-insulating sheet 304 having light transmission. Accordingly, the user can easily visually recognize the stored items of the refrigerator 1H and the aesthetics of the refrigerator 1H can be improved.

The chilled chamber upper surface partition portion 96a and the chilled chamber lid 98 may be formed of the specific heat-insulating material 209 instead of synthetic resin or glass. In this case, the chilled chamber upper surface partition portion 96a and the chilled chamber lid 98 have heat-insulating properties without adhering the third partition wall heat-insulating sheet 303 and the fourth partition wall heat-insulating sheet 304. Accordingly, the chilled chamber upper surface partition portion 96a and the chilled chamber lid 98 can have a simple structure and the manufacturing process can be simplified in addition to the above-described effect.

The third partition wall heat-insulating sheet 303 may be adhered to the upper surface of the chilled chamber upper surface partition portion 96a instead of being adhered to the lower surface of the chilled chamber upper surface partition portion 96a. The fourth partition wall heat-insulating sheet 304 may be adhered to the outer surface of the chilled chamber lid 98 instead of being adhered to the inner surface of the chilled chamber lid 98.

### Sixth Embodiment

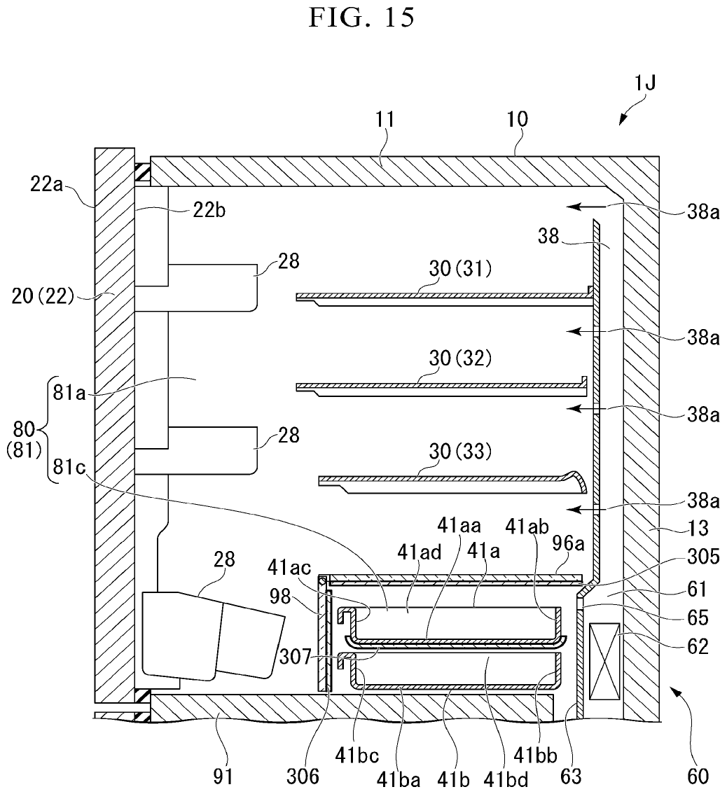

FIG. 15 is a cross-sectional view showing a refrigerator 1J of a sixth embodiment. The refrigerator 1J of the sixth embodiment is different from the refrigerator 1H of the fifth embodiment in that a two-stage tray is disposed in the chilled chamber 81c.

The refrigerator 1J of the sixth embodiment includes an upper chilled case 41a, a lower chilled case 41b, the chilled chamber upper surface partition portion 96a, the chilled chamber lid 98, a fifth partition wall heat-insulating sheet 305, a sixth partition wall heat-insulating sheet 306, and a seventh partition wall heat-insulating sheet 307. The chilled chamber 81c is partitioned from the normal refrigerating chamber 81a by the chilled chamber upper surface partition portion 96a and the chilled chamber lid 98.

The upper chilled case 41a and the lower chilled case 41b are provided inside the chilled chamber 81 c to be taken in and out. At least the chilled chamber upper surface partition portion 96a, the chilled chamber lid 98, and the upper chilled case 41a are formed of, for example, a member such as synthetic resin and glass having light transmission. The lower chilled case 41b is also formed of, for example, a member such as synthetic resin or glass having light transmission.

The fifth partition wall heat-insulating sheet 305, the sixth partition wall heat-insulating sheet 306, and the seventh partition wall heat-insulating sheet 307 are formed of, for example, the specific heat-insulating material 209. By a double-sided tape or adhesive having light transmission, the fifth partition wall heat-insulating sheet 305 is adhered to the lower surface of the chilled chamber upper surface partition portion 96a, the sixth partition wall heat-insulating sheet 306 is adhered to the back surface of the chilled chamber lid 98, and the seventh partition wall heat-insulating sheet 307 is adhered to a bottom portion 41aa of the upper chilled case 41a. The lower chilled case 41b is an example of the “first tray”. The upper chilled case 41a is an example of the “second tray”. The bottom portion 41aa of the upper chilled case 41a and a portion attached to the bottom portion 41aa in the seventh partition wall heat-insulating sheet 307 constitute an example of the bottom portion of the second tray.

Specifically, the upper chilled case 41a includes, for example, the bottom portion 41aa, a rear wall 41ab, a front wall 41ac, and left and right walls (only a left wall 41ad is shown) and is formed in a bowl shape to be opened upward. The bottom portion 41aa extends horizontally and is located between the inside (the storage space) of the upper chilled case 41a and the inside (the storage space) of the lower chilled case 41b. The rear wall 41ab stands upright from the rear end portion of the bottom portion 41aa. The rear wall 41ab is a wall portion which is closer to the chilling cold air supply port 65 than the bottom portion 41aa, the front wall 41ac, and the left and right walls. The front wall 41ac stands upright from the front end portion of the bottom portion 41aa. The left and right walls stand upright from the left and right end portions of the bottom portion 41aa.

The chilling cold air supply port 65 is provided in a front wall portion 63 of the refrigerating cooler chamber 61 (a rear wall portion of the chilled chamber 81c). In this embodiment, the chilling cold air supply port 65 is provided behind the upper chilled case 41a. For example, the chilling cold air supply port 65 is located on the side opposite to the lower chilled case 41b with respect to the bottom portion 41aa of the upper chilled case 41a in the up and down direction of the refrigerator 1.

The seventh partition wall heat-insulating sheet 307 is adhered to, for example, the lower surface of the bottom portion 41aa and covers substantially the entire area of the bottom portion 41aa. On the other hand, a part of the rear wall 41ab (for example, a half or more including a region close to the chilling cold air supply port 65) is not covered with the seventh partition wall heat-insulating sheet 307. Therefore, cold air supplied from the chilling cold air supply port 65 to the chilled chamber 81c can efficiently cool the inside of the upper chilled case 41a.

However, the seventh partition wall heat-insulating sheet 307 may be attached to the rear wall 41ab and may cover substantially the entire area of the rear wall 41ab. In this case, since the cold air of the chilling cold air supply port 65 is difficult to be transmitted to the upper chilled case 41a, it is possible to suppress the vicinity of the rear wall 41ab in the upper chilled case 41a from being locally overcooled.

As shown in the drawing, the cold air taken from the refrigerating blower fan 64 and cooled by the refrigerating cooler 62 is blown out from the chilling cold air supply port 65 to the vicinity of the upper chilled case 41a of the chilled chamber 81c at a first temperature. Part of the cold air having cooled the upper chilled case 41a cools the stored items such as food of the upper chilled case 41a and the temperature of the upper chilled case 41a rises by the heat exchange with the stored items. Then, the cold air flows along the chilled chamber lid 98, flows into the lower chilled case 41b at a second temperature higher than the first temperature, and cools the stored items of the lower chilled case 41b. Subsequently, the cold air is sucked by the refrigerating blower fan 64, passes behind the vegetable chamber 82, and returns from the refrigerating chamber suction port 36 to the refrigerating cooler 62.

According to the refrigerator 1J of the sixth embodiment, it is possible to obtain the same effect as that of the refrigerator 1H of the fifth embodiment. In addition, according to the refrigerator 1J of the sixth embodiment, it is possible to impart a temperature difference between the upper chilled case 41a and the lower chilled case 41b by increasing the heat-insulating property of the upper chilled case 41a. That is, the upper chilled case 41a can be kept at a temperature lower than that of the lower chilled case 41b. Accordingly, it is possible to properly use the upper chilled case 41a and the lower chilled case 41b depending on the type of food such that food such as meat and seafood easily damaged when stored in a thawing state is stored in the upper chilled case 41a and fresh food stored without freezing is stored in the lower chilled case 41b.

The user can see the inside of the upper chilled case 41 a and the lower chilled case 41b through the chilled chamber upper surface partition portion 96a, the chilled chamber lid 98, and the upper chilled case 41a having light transmission. Accordingly, the user can easily visually recognize the stored items of the refrigerator 1H and the aesthetics of the refrigerator 1J can be improved.

Similarly to the above-described modified examples, the chilled chamber upper surface partition portion 96a, the chilled chamber lid 98, and the upper chilled case 41a may be formed of the specific heat-insulating material 209 instead of adhering the fifth partition wall heat-insulating sheet 305, the sixth partition wall heat-insulating sheet 306, and the seventh partition wall heat-insulating sheet 307. In this case, it is possible to obtain the same effect as that of the refrigerator of each of the above-described modified examples in addition to the effect of the refrigerator 1H of the sixth embodiment.

The chilling cold air supply port 65 may be provided behind the lower chilled case 41b instead of being provided behind the upper chilled case 41a. In this case, the chilling cold air supply port 65 is located on the side opposite to the upper chilled case 41a with respect to the bottom portion 41aa of the upper chilled case 41a in the up and down direction of the refrigerator 1. In this case, the lower chilled case 41b can be kept at a temperature lower than that of the upper chilled case 41a.

### Seventh Embodiment

FIG. 16 is a cross-sectional view showing a refrigerator 1K of a seventh embodiment. The refrigerator 1K of the seventh embodiment is different from the refrigerator 1 of the first embodiment in that the ice-making water supply tank chamber partition wall 97 between the ice-making water supply tank chamber 81b and the chilled chamber 81c is formed of a member such as synthetic resin or glass having light transmission and an eighth partition wall heat-insulating sheet 308 is provided on a side of the ice-making water supply tank chamber 81b of the ice-making water supply tank chamber partition wall 97. The other configurations of the refrigerator 1K are the same as those of the refrigerator 1 of the first embodiment. In this embodiment, the chilled chamber upper surface partition portion 96, the ice-making water supply tank chamber partition wall 97, and the eighth partition wall heat-insulating sheet 308 constitute an example of the “partition member” that partitions the inside of the refrigerating chamber 81 into the first storage portion and the second storage portion. The ice-making water supply tank chamber partition wall 97 and the eighth partition wall heat-insulating sheet 308 constitute an example of the “side plate”.

The ice-making water supply tank chamber partition wall 97 (the left wall of the chilled chamber 81c) and the inner surface (the right wall of the chilled chamber 81c) of the right wall 15 are respectively provided with chilled chamber protrusion portions 131 and 132 which are rails guiding the movement of the chilled case 41 in the front and rear direction.

The eighth partition wall heat-insulating sheet 308 is formed of, for example, the specific heat-insulating material 209 and is adhered to the ice-making water supply tank chamber 81b of the ice-making water supply tank chamber partition wall 97 by a double-sided tape or adhesive having light transmission. The eighth partition wall heat-insulating sheet 308 has a size covering substantially the entire region of the ice-making water supply tank chamber partition wall 97.

According to the refrigerator 1K of the seventh embodiment, since it is possible to suppress the water stored in the ice-making water supply tank 510 of the ice-making water supply tank chamber 81b from being frozen by the cold air of the chilled chamber 81c, for example, a heater or the like does not need to be provided below the ice-making water supply tank 510 and the refrigerator can be manufactured at low cost. Further, the user can see the ice-making water supply tank 510 of the ice-making water supply tank chamber 81b from the chilled chamber 81c through the ice-making water supply tank chamber partition wall 97 and the eighth partition wall heat-insulating sheet 308 having light transmission. Accordingly, the ice-making water supply tank 510 of the ice-making water supply tank chamber 81b can be easily visually recognized and the aesthetics of the refrigerator 1K can be improved.

In addition, the eighth partition wall heat-insulating sheet 308 may be provided on the side opposite to the ice-making water supply tank chamber 81b of the ice-making water supply tank chamber partition wall 97 (that is, a surface exposed into the chilled chamber 81c in the ice-making water supply tank chamber partition wall 97). The eighth partition wall heat-insulating sheet 308 may be provided on both the side of the ice-making water supply tank chamber 81b of the ice-making water supply tank chamber partition wall 97 and the side opposite to the ice-making water supply tank chamber 81b of the ice-making water supply tank chamber partition wall 97.

In addition, the ice-making water supply tank chamber partition wall 97 may be formed of the specific heat-insulating material 209. In this case, the ice-making water supply tank chamber partition wall 97 has a heat-insulating property even when the eighth partition wall heat-insulating sheet 308 is not adhered. Accordingly, the chilled chamber upper surface partition portion 96a and the chilled chamber lid 98 can have a simple structure and the manufacturing process can be simplified in addition to the above-described effect.

### Eighth Embodiment

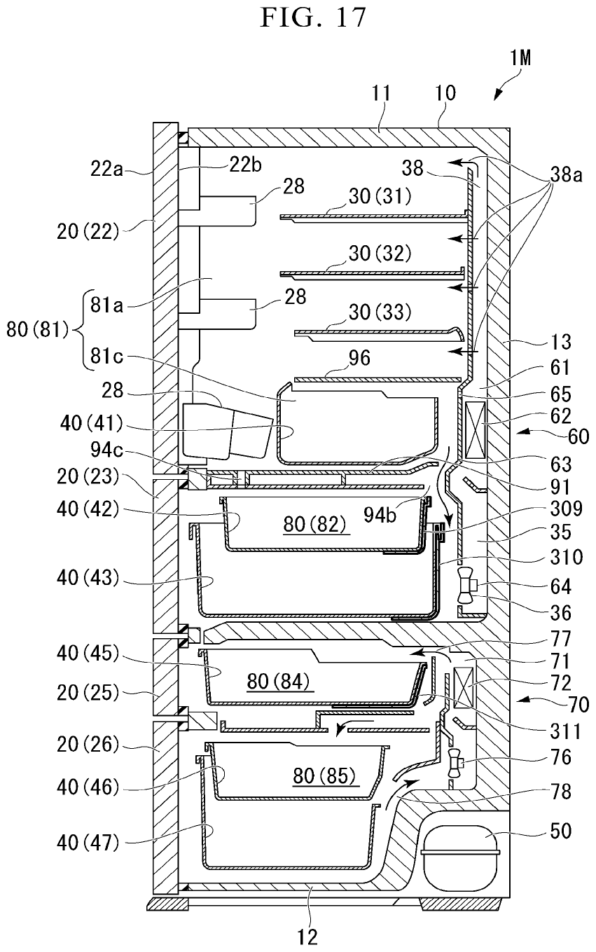

FIG. 17 is a cross-sectional view showing a refrigerator 1M of an eighth embodiment. The refrigerator 1M of the eighth embodiment is different from the refrigerator 1 of the first embodiment in that a partition wall heat-insulating sheet is provided on the inner side of the container where cold air hits strongly. The other configurations of the refrigerator 1M of the eighth embodiment are the same as those of the refrigerator 1 of the first embodiment.

A ninth partition wall heat-insulating sheet 309, a tenth partition wall heat-insulating sheet 310, and an eleventh partition wall heat-insulating sheet 311 are formed of, for example, the specific heat-insulating material 209. Each of the first vegetable chamber container 42, the second vegetable chamber container 43, and the small freezing chamber container 45 is formed of, for example, a member such as synthetic resin or glass having light transmission.

Each of the first vegetable chamber container 42, the second vegetable chamber container 43, and the small freezing chamber container 45 includes a bottom wall, a front wall, a rear wall, and left and right walls. As shown in the drawing, the ninth partition wall heat-insulating sheet 309, the tenth partition wall heat-insulating sheet 310, and the eleventh partition wall heat-insulating sheet 311 are adhered to the rear side of the center of the bottom wall and the rear wall in the containers of the first vegetable chamber container 42, the second vegetable chamber container 43, and the small freezing chamber container 45 by a double-sided tape or adhesive having light transmission. The place where the ninth partition wall heat-insulating sheet 309, the tenth partition wall heat-insulating sheet 310, and the eleventh partition wall heat-insulating sheet 311 are adhered is not particularly limited. It is preferable that the adhering position be a position exposed to strong cold air.

In this embodiment, the first vegetable chamber container 42, the ninth partition wall heat-insulating sheet 309, the second vegetable chamber container 43, the tenth partition wall heat-insulating sheet 310, the small freezing chamber container 45, and the eleventh partition wall heat-insulating sheet 311 respectively constitute an example of the “container”. The rear wall of the first vegetable chamber container 42 and a portion attached to the rear wall in the ninth partition wall heat-insulating sheet 309 constitute an example of the wall portion located at a position closest to the cold air inlet (the rear vent 94b) among the plurality of wall portions (the bottom wall, the front wall, and the left and right walls) of the container. Similarly, the rear wall of the second vegetable chamber container 43 and a portion attached to the rear wall in the tenth partition wall heat-insulating sheet 310 constitute an example of the wall portion located at a position closest to the cold air inlet (the rear vent 94b) among the plurality of wall portions (the bottom wall, the front wall, and the left and right walls) in the container. Similarly, the rear wall of the small freezing chamber container 45 and a portion attached to the rear wall in the eleventh partition wall heat-insulating sheet 311 constitute an example of the wall portion located at a position closest to the cold air inlet (the cold air outlet 77) among the plurality of wall portions (the bottom wall, the front wall, and the left and right walls) in the container.

As described above, cold air flows from the refrigerating chamber 81 into the vegetable chamber 82 through the rear vent 94b of the first partition wall 91. Therefore, the low-temperature cold air flows to a back surface portion of the first vegetable chamber container 42 and the back surface portion of the second vegetable chamber container 43 and in these back surface portions, food is more likely to be exposed to a lower temperature than the position other than the back surface portions of the first vegetable chamber container 42 and the second vegetable chamber container 43. As described above, since the cold air generated by the freezing cooler 72 is supplied from the cold air outlet 77 into the small freezing chamber 84, the low-temperature cold air flows to the back surface portion of the small freezing chamber container 45 and in this back surface portion, food is more likely to be exposed to a lower temperature than the position other than the back surface portion of the small freezing chamber container 45.

Thus, in the refrigerator 1M of the eighth embodiment, the ninth partition wall heat-insulating sheet 309, the tenth partition wall heat-insulating sheet 310, and the eleventh partition wall heat-insulating sheet 311 are respectively adhered to the rear side of the center of the bottom wall portion and the back surface portion in the containers of the first vegetable chamber container 42, the second vegetable chamber container 43, and the small freezing chamber container 45. Accordingly, it is possible to suppress food on these back surface portions from being exposed to a low temperature caused by the blown cold air.

According to the refrigerator 1M of the eighth embodiment, the partition wall heat-insulating sheet is adhered to the rear side of the center of the bottom wall portion and the back surface portion of the container where cold air strongly hits. For that reason, it is possible to suppress only food on the inner side from being overcooled in the vegetable chamber 82 or the small freezing chamber 84. Since the ninth partition wall heat-insulating sheet 309, the tenth partition wall heat-insulating sheet 310, and the eleventh partition wall heat-insulating sheet 311 transmit light, visibility or aesthetics is not impaired.

### Ninth Embodiment

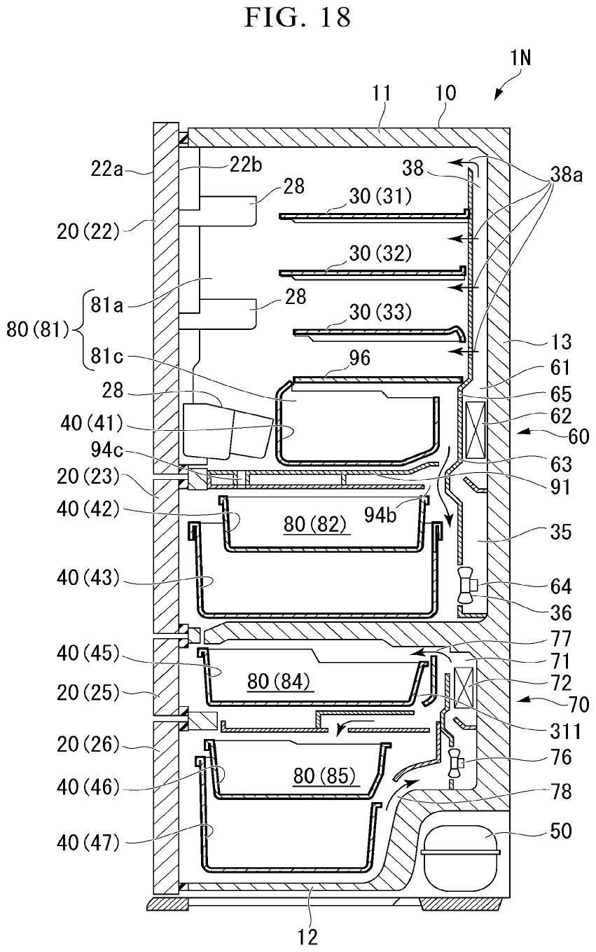

FIG. 18 is a cross-sectional view of a refrigerator 1N of a ninth embodiment. The refrigerator 1N of the ninth embodiment has the same configuration as that of the refrigerator 1M of the eighth embodiment, but is different from the refrigerator 1M of the eighth embodiment in that shelves or containers are formed of the specific heat-insulating material 209 instead of the ninth partition wall heat-insulating sheet 309, the tenth partition wall heat-insulating sheet 310, and the eleventh partition wall heat-insulating sheet 311. That is, in the refrigerator 1N, all or part of the plurality of shelves 30, the chilled case 41, the first vegetable chamber container 42, the second vegetable chamber container 43, the ice-making chamber container 44, the small freezing chamber container 45, the first main freezing chamber container 46, the second main freezing chamber container 47, and the ice-making water supply tank 510 are formed of the specific heat-insulating material 209. Thus, even when the ninth partition wall heat-insulating sheet 309, the tenth partition wall heat-insulating sheet 310, and the eleventh partition wall heat-insulating sheet 311 are not adhered, the plurality of shelves 30, the chilled case 41, the first vegetable chamber container 42, the second vegetable chamber container 43, the ice-making chamber container 44, the small freezing chamber container 45, the first main freezing chamber container 46, and the second main freezing chamber container 47 have heat-insulating properties.

According to the refrigerator 1N of the ninth embodiment, it is possible to obtain the same effect as that of the refrigerator 1M of the eighth embodiment. In addition, according to the refrigerator 1N of the ninth embodiment, it is possible to simplify the structures of the plurality of shelves 30, the chilled case 41, the first vegetable chamber container 42, the second vegetable chamber container 43, the ice-making chamber container 44, the small freezing chamber container 45, the first main freezing chamber container 46, and the second main freezing chamber container 47 and simplify the manufacturing process.

According to at least one of the above-described embodiments, since the refrigerator includes the housing, the door, and the interior member and at least part of at least one of the housing, the door, and the interior member is formed of a light-transmitting heat-insulating material containing aerogel, xerogel, or cryogel, it is possible to improve the convenience of the refrigerator.

Although some embodiments of the present invention have been described, these embodiments are suggested as examples and are not intended to limit the scope of the invention. These embodiments can be implemented in various other forms and various omissions, replacements, and changes can be made without departing from the gist of the invention. These embodiments and modifications thereof are included in the scope of the invention described in the claims and the equivalent scope thereof as they are included in the scope and gist of the invention.

### REFERENCE SIGNS LIST

1, 1A to 1N Refrigerator

10 Housing

20 (21 to 26) Door

40 (41 to 47) Container

80 (81 to 86) Storage chamber

91, 91D, 91E First partition wall

94c Front vent

94b Rear vent

95, 95F, 95G Second partition wall

96, 96a Chilled chamber upper surface partition portion

97 Ice making water supply tank chamber partition wall

98 Chilled chamber lid

112 Window portion

202, 202A, 202B Front plate

209, 209A, 209B Specific heat-insulating material (transparent heat-insulating material)

301 to 311 First to eleventh partition wall heat-insulating sheets

400 Lighting unit

402 Light emitter

404 Lighting cover

510 Ice making water supply tank

1. A refrigerator comprising:
a housing which includes a storage chamber;
a door which closes the storage chamber so as to be openable; and
an interior member which is disposed inside the housing,
wherein at least part of at least one of the housing, the door, and the interior member is formed of a light-transmitting heat-insulating material containing aerogel, xerogel, or cryogel.

2. The refrigerator according to claim 1,
wherein the door includes a window portion through which an inside of the storage chamber is visually recognizable from an outside of the refrigerator, and
wherein at least part of the window portion is formed of the light-transmitting heat-insulating material.

3. The refrigerator according to claim 1, further comprising:
a light emitter which illuminates an inside of the storage chamber,
wherein the interior member is a lighting cover which covers the light emitter, and
wherein at least part of the lighting cover is formed of the light-transmitting heat-insulating material.

4. The refrigerator according to claim 1,
wherein the housing includes a plurality of the storage chambers including the storage chamber and a partition portion provided between the plurality of storage chambers, and
wherein at least part of the partition portion is formed of the light-transmitting heat-insulating material.

5. The refrigerator according to claim 1,
wherein the interior member is a partition member that partitions an inside of the storage chamber into a first storage portion and a second storage portion which is cooled to a temperature zone lower than that of the first storage portion, and
wherein at least part of the partition member is formed of the light-transmitting heat-insulating material.

6. The refrigerator according to claim 5,
wherein the second storage portion is provided below at least part of the first storage portion,
wherein the partition member includes a ceiling plate portion which is located between the first storage portion and the second storage portion and forms a ceiling portion of the second storage portion, and
wherein at least part of the ceiling plate portion is formed of the light-transmitting heat-insulating material.

7. The refrigerator according to claim 5,
wherein the partition member includes a lid which is located on a front side of the second storage portion and closes the second storage portion so as to be openable, and
wherein at least part of the lid is formed of the light-transmitting heat-insulating material.

8. The refrigerator according to claim 5, further comprising:
a plurality of trays which are disposed in the second storage portion and includes a first tray and a second tray disposed above the first tray,
wherein at least part of a bottom portion of the second tray is formed of the light-transmitting heat-insulating material.

9. The refrigerator according to claim 5, further comprising:
a water storage container which is disposed on a side of the second storage portion and stores ice-making water,
wherein the partition member includes a side plate which is disposed between the water storage container and the second storage portion, and
wherein at least part of the side plate is formed of the light-transmitting heat-insulating material.

10. The refrigerator according to claim 1, further comprising:
a partition member that partitions an inside of the storage chamber into a first storage portion and a second storage portion which is cooled to a temperature zone lower than that of the first storage portion,
wherein the interior member is a water storage container which is disposed on a side of the second storage portion and stores ice-making water, and
wherein at least part of the water storage container is formed of the light-transmitting heat-insulating material.

11. The refrigerator according to claim 1, further comprising:
a housing interior structure component which is disposed inside the housing and includes a cold air inlet allowing cold air to flow into the storage chamber,
wherein the interior member is a container which includes a plurality of wall portions and stores food, and
wherein at least part of the wall portion closest to the cold air inlet among the plurality of wall portions of the container is formed of the light-transmitting heat-insulating material.
